(19) United States
(12) Patent Application Publication
(10) Pub. No.: US 2013/0140496 A1
(43) Pub. Date: Jun. 6, 2013

(54) SUBSTITUTED LITHIUM-MANGANESE METAL PHOSPHATE

(71) Applicants: Gerhard Nuspl, Munchen (DE); Nicolas Tran, Nandlstadt (DE)

(72) Inventors: Gerhard Nuspl, Munchen (DE); Nicolas Tran, Nandlstadt (DE)

(73) Assignee: SUED-CHEMIE IP GMBH & CO. KG, Munich (DE)

(21) Appl. No.: 13/575,664

(22) PCT Filed: Jan. 28, 2011
(86) PCT No.: PCT/EP2011/051189

§ 371 Date: Dec. 6, 2012

(30) Foreign Application Priority Data
Jan. 28, 2010 (DE) 10 2010 006 083.6

(51) Int. Cl. H01M 4/58; H01M 4/62; H01M 4/36

(52) U.S. Cl. CPC H01M 4/5825; H01M 4/366; H01M 4/625
USPC 252/507; 252/182.1; 252/509; 252/506

(57) ABSTRACT

A substituted lithium-manganese metal phosphate of formula

LiFeₓMn_{1-x-y}M_{y}PO₄

in which M is a bivalent metal from the group Sn, Pb, Zn, Mg, Ca, Sr, Ba, Co, Ti and Cd and wherein: x<1, y<0.3 and x+y<1, a process for producing it as well as its use as cathode material in a secondary lithium-ion battery.

### CROSS-REFERENCE TO RELATED APPLICATIONS

This application is a U.S. National Stage application claiming benefit of International Application No. PCT/EP2011/051189, filed Jan. 28, 2011, and claiming benefit of German Application No. DE 10 2010 006 083.6, filed Jan. 28, 2010. The entire disclosures of both PCT/EP2011/051189 and DE 10 2010 006 083.6 are incorporated herein by reference.

### BACKGROUND

The present invention relates to a novel substituted lithium-manganese metal phosphate, a process for producing it as well as its use as cathode material in a secondary lithium-ion battery.

Since the publications by Goodenough et al. (J. Electrochem. Soc., 144, 1188-1194, 1997) there has been significant interest in particular in using lithium iron phosphate as cathode material in rechargeable secondary lithium-ion batteries. Lithium iron phosphate, compared with conventional lithium compounds based on spinels or layered oxides, such as lithium manganese oxide, lithium cobalt oxide and lithium nickel oxide, offers higher safety properties in the delithiated state such as are required in particular for the use of batteries in future in electric cars, electrically powered tools etc.

Pure lithium iron phosphate material was improved by so-called “carbon coating” (Ravet et al., Meeting of Electrochemical Society, Honolulu, 17-31 Oct. 1999, EP 1 084 182 B1), as an increased reversible capacity of the carbon-coated material is achieved at room temperature (160 mAH/g).

In addition to customary solid-state syntheses (U.S. Pat. No. 5,910,382 C1 or U.S. Pat. No. 6,514,640 C1), a hydrothermal synthesis for lithium iron phosphate with the possibility of controlling the size and morphology of the lithium iron phosphate particles was disclosed in WO 2005/051840.

A disadvantage of lithium iron phosphate is in particular its redox couple Fe³⁺/Fe²⁺ which has a much lower redox potential vis-à-vis Li/Li⁺ (3.45 V versus Li/Li⁺) than for example the redox couple Co³⁺/Co⁴⁺ in LiCoO₂ (3.9 V versus Li/Li⁺).

In particular lithium manganese phosphate LiMnPO₄ is of interest in view of its higher Mn²⁺/Mn³⁺ redox couple (4.1 volt) versus Li/Li⁺. LiMnPO₄ was also already disclosed by Goodenough et al., U.S. Pat. No. 5,910,382.

However, the production of electrochemically active and in particular carbon-coated LiMnPO₄ has proved very difficult.

The electrical properties of lithium manganese phosphate were improved by iron substitution of the manganese sites:

Herle et al. in Nature Materials, Vol. 3, pp. 147-151 (2004) describe lithium-iron and lithium-nickel phosphates doped with zirconium. Morgan et al. describes in Electrochem. Solid State Lett. 7 (2), A30-A32 (2004) the intrinsic lithium-ion conductivity in LiₓMPO₄ (M=Mn, Fe, Co, Ni) olivines. Yamada et al. in Chem. Mater. 18, pp. 804-813, 2004 deal with the electrochemical, magnetic and structural features of Liₓ(Mn_{y}Fe_{1-y})PO₄, which are also disclosed e.g. in WO2009/009758. Structural variations of Liₓ(Mn_{y}Fe_{1-y})PO₄, i.e. of the lithiophilite-triphylite series, were described by Losey et al. The Canadian Mineralogist, Vol. 42, pp. 1105-1115 (2004). The practical effects of the latter investigations in respect of the diffusion mechanism of deintercalation in Liₓ(Mn_{y}Fe_{1-y})PO₄ cathode material are found in Molenda et al. Solid State Ionics 177, 2617-2624 (2006).

However, a plateau-like region occurs for the discharge curves at 3.5 volt vis-à-vis lithium (iron plateau), the length of which compared with pure LiMnPO₄ increases as the iron content increases, which results in a loss of energy density (see Yamada et al. in the publication mentioned above). The slow kinetics (charge and discharge kinetics) in particular of Liₓ(Mn_{y}Fe_{1-y})PO₄ with y>0.8 have so far made the use of these compounds for battery applications largely impossible.

### SUMMARY

The object of the present invention was therefore to provide suitable lithium-manganese phosphate derivatives which make possible a high energy density when used as cathode material and provide a high redox potential with rapid kinetics in respect of charge and discharge processes.

This object is achieved by a substituted lithium-manganese metal phosphate of formula

LiFeₓMn_{1-x-y}M_{y}PO₄

in which M is a bivalent metal from the group Sn, Pb, Zn, Mg, Ca, Sr, Ba, Co, Ti and Cd and wherein: x<1, y<0.3 and x+y<1.

Particularly preferred as bivalent metal is M, Zn or Ca or combinations thereof, in particular Zn. It has surprisingly been shown within the framework of the present invention that these electrically inactive substitution elements make possible the provision of materials with particularly high energy density when they are used as electrode materials.

It was found that in the case of the substituted lithium metal phosphate of the present invention LiFeₓMn_{1-x-y}M_{y}PO₄, the value for y lies in the range of more than 0.07 to 0.20 and is preferably 0.1.

The substitution (or doping) by the bivalent metal cations that are in themselves electrochemically inactive seems to deliver the very best results at values of x=0.1 and y=0.1-0.15, preferably 0.1-0.13, in particular 0.11±0.1 with regard to energy density of the material according to the invention. For the doping with magnesium (LiMn_{1-x-y}Mg_{y}PO₄), values slightly different from Zn and Ca were found. Here, 0.01≦x≦0.11 and 0.07≦y≦20, preferably 0.075≦y≦15 and x+y must be <0.2. This means that a high manganese content with a relatively low iron content and a relatively high magnesium content deliver the best results in respect of energy density, which is particularly surprising in view of the electrically inactive character of magnesium. It was found that for compounds according to the invention such as LiMn_{0.80}Fe_{0.10}Mg_{0.10}PO₄, LiMn_{0.80}Fe_{0.10}Zn_{0.10}PO_{y} and LiMn_{0.80}Fe_{0.10} Ca_{0.10}PO₄ a discharge capacity at C/10 was greater than 140 mAh/g when the synthesis temperature was less than 650° C.

In further preferred embodiments of the present invention, the value for x in the mixed lithium metal phosphate according to the invention of general formula LiFeₓMn_{1-x-y}M_{y}PO₄ is 0.01-0.4, particularly preferably 0.5-0.2, quite particularly preferably 0.15±0.3. This value, in particular in conjunction with the above-named particularly preferred value for y gives the most preferred compromise between energy density and current carrying capacity of the material according to the invention. This means that the compound LiFeₓMn_{1-x-y}M_{y}PO₄ for M=Zn or Ca with x=0.33 and y=0.10 has a current carrying capacity up to 20 C during discharge comparable with that of LiFePO₄ of the state of the art (e.g. available from Süd-Chemie), but in addition also an increase in energy density (approx. 20% vis-à-vis LiFePO₄ (measured against a lithium titanate (Li₄Ti₅O₁₂) anode).

In further preferred embodiments of the present invention, the substituted lithium-manganese metal phosphate also comprises carbon. The carbon is particularly preferably evenly distributed throughout the substituted lithium-manganese metal phosphate. In other words, the carbon forms a type of matrix in which the lithium-manganese metal phosphate according to the invention is embedded. It makes no difference for the meaning of the term “matrix” used here whether e.g. the carbon particles serve as “nucleation sites” for the LiFeₓMn_{1-x-y}M_{y}PO₄ according to the invention, i.e. whether these settle on the carbon, or whether, as in a particularly preferred development of the present invention, the individual particles of the lithium-manganese metal phosphate LiFeₓMn_{1-x-y}M_{y}PO₄ are covered in carbon, i.e. sheathed or in other words coated. Both variants are considered equivalent according to the invention and come under the above definition.

Important for the purpose of the present invention is merely that the carbon is evenly distributed in the substituted lithium-manganese metal phosphate LiFeₓMn_{1-x-y}M_{y}PO₄ according to the invention and forms a type of (three-dimensional) matrix. In advantageous developments of the present invention, the presence of carbon or a carbon matrix can make obsolete the further addition of electrically conductive additives when using the LiFeₓMn_{1-x-y}M_{y}PO₄ according to the invention as electrode material.

The proportion of carbon relative to the substituted lithium-manganese metal phosphate is ≦4 wt.-%, in other embodiments less than 2.5 wt.-%, in still others less than 2.2 wt.-% and in still further embodiments less than 2.0 wt.-%. The best energy densities of the material according to the invention are achieved according to the invention.

The substituted lithium-manganese metal phosphate LiFeₓMn_{1-x-y}M_{y}PO₄ according to the invention is preferably contained as active material in a cathode for a secondary lithium-ion battery. This cathode can also contain the LiFeₓMn_{1-x-y}M_{y}PO₄ according to the invention without further addition of a further conductive material such as e.g. conductive carbon black, acetylene black, ketjen black, graphite etc. (in other words be free of added conductive agent), both in the case of the carbon-containing LiFeₓMn_{1-x-y}M_{y}PO₄ according to the invention and the carbon-free LiFeₓMn_{1-x-y}M_{y}PO₄.

In further preferred embodiments, the cathode according to the invention contains a further lithium-metal-oxygen compound. This addition increases the energy density depending on the quantity by up to approx. 10-15%, depending on the type of the further mixed lithium metal compound compared with cathodes which contain only the LiFeₓMn_{1-x-y}M_{y}PO₄ according to the invention as sole active material.

The further lithium-metal-oxygen compound is preferably selected from substituted or non-substituted LiCoO₂, LiMn₂O₄, Li(Ni,Mn,Co)O₂, Li(Ni,Co,Al)O₂ and LiNiO₂, as well as Li(Fe,Mn)PO₄ and mixtures thereof.

The object is further achieved by a process for producing a mixed lithium-manganese metal phosphate according to the invention comprising the following steps:
a. producing a mixture containing a Li starting compound, a Mn starting compound, an Fe starting compound, a M²⁺ starting compound and a PO₄³⁻ starting compound,
b. heating the mixture at a temperature of 450-850°;
c. isolating LiFeₓMn_{1-x-y}M_{y}PO₄, wherein x and y have the above-named meanings.

The process according to the invention makes possible in particular the production of phase-pure LiFeₓMn_{1-x-y}M_{y}PO₄ which is free of impurities to be determined by means of XRD.

There is therefore also a further aspect of the present invention in the provision of LiFeₓMn_{1-x-y}M_{y}PO₄ which can be obtained by means of the process according to the invention.

After heating (sintering), the LiFeₓMn_{1-x-y}M_{y}PO₄ obtained according to the invention is isolated and, in preferred developments of the invention, disagglomerated, e.g. by grinding with an air-jet mill.

In developments of the process according to the invention, a carbon-containing material is added in step a) or after step c). This can be either pure carbon, such as e.g. graphite, acetylene black or ketjen black, or else a carbon-containing precursor compound which then decomposes when exposed to the action of heat to carbon, e.g. starch, gelatine, a polyol, cellulose, a sugar such as mannose, fructose, sucrose, lactose, galactose, a partially water-soluble polymer such as e.g. a polyacrylate etc.

Alternatively, the LiFeₓMn_{1-x-y}M_{y}PO₄ obtained after the synthesis can also be mixed with a carbon-containing material as defined above or impregnated with an aqueous solution of same. This can take place either directly after the isolation of the LiFeₓMn_{1-x-y}M_{y}PO₄ or after it has been dried or disagglomerated.

For example the mixture of LiFeₓMn_{1-x-y}M_{y}PO₄ and carbon precursor compound (which was added e.g. during the process) or the LiFeₓMn_{1-x-y}M_{y}PO₄ impregnated with the carbon precursor compound is then dried and heated to a temperature between 500° C. and 850° C., wherein the carbon precursor compound is pyrolyzed to pure carbon which then wholly or at least partly covers the LiFeₓMn_{1-x-y}M_{y}PO₄ particles as a layer.

The pyrolysis is usually followed by a grinding or disagglomeration treatment.

The LiFeₓMn_{1-x-y}M_{y}PO₄ obtained according to the invention is preferably pyrolyzed under protective gas, preferably nitrogen, in air or under vacuum.

Within the framework of the process according to the invention, the Li⁺ source, iron source, i.e. either an Fe²⁺- or Fe³⁺, and Mn²⁺ sources as well as the M²⁺ source are preferably used in the form of solids and also the PO₄³⁻ source in the form of a solid, i.e. a phosphate, hydrogen phosphate or dihydrogen phosphate or P₂O₅.

According to the invention, Li₂O, LiOH or Li₂CO₃, lithium oxalate or lithium acetate, preferably LiOH or Li₂CO₃, is used as lithium source.

The Fe source is preferably an Fe²⁺ compound, in particular FeSO₄, FeCl₂, Fe(NO₃)₂, Fe₃(PO₄)₂ or an Fe organyl salt, such as iron oxalate or iron acetate. In other embodiments of the invention, the iron source is an Fe³⁺ compound, in particular selected from FePO₄, Fe₂O₃ or a compound with mixed oxidation stages or compounds such as Fe₃O₄. If a trivalent iron salt is used, however, in step a) of the process according to the invention a carbon-containing compound as above must be added, or carbon in the form of graphite, carbon black, ketjen black, acetylene black etc. This reduces the trivalent iron to bivalent iron (so-called carbothermal reduction) during the process according to the invention. After carrying out the process, the end-product then either still contains carbon (typically evenly distributed in the product), if carbon was used in excess, or, in the case of stoichiometric addition, no longer contains carbon. In a further variant, a further carbon coating as stated above is then also possible.

All suitable bivalent or trivalent manganese compounds, such as oxides, hydroxides, carbonates, oxalates, acetates etc. such as MnSO₄, MnCl₂, MnCO₃, MnO, MnHPO₄, manganese oxalate, manganese acetate or a Mn³⁺ salt, selected from MnPO₄, Mn₂O₃ or a manganese compound with mixed oxidation stages such as Mn₃O₄ come into consideration as manganese source. If a trivalent manganese compound is used, there must be a carbon-containing reductant in the mixture in step a) in stoichiometric or hyperstoichiometric quantity relative to the trivalent manganese, as stated above in the case of iron.

As a process variant, it is possible according to the invention to use either only bivalent manganese and iron compounds, or a trivalent iron compound and a bivalent manganese compound, further a bivalent iron compound and a trivalent manganese compound, or else also one trivalent iron and one manganese compound. If at least one trivalent iron or manganese compound is used, naturally a quantity of carbon (or a corresponding quantity of a carbon-containing compound) at least stoichiometric or hyperstoichiometric relative to it must be contained in the mixture in step a) of the process according to the invention.

According to the invention, a metal phosphate, hydrogen phosphate or dihydrogen phosphate, such as e.g. LiH₂PO₄, LiPO₃, FePO₄, MnPO₄, i.e. the corresponding iron and manganese compounds or the corresponding compounds of the bivalent metals as defined above is preferably used as PO₄³⁻ source. P₂O₅ can also be used according to the invention.

In particular, as already stated, the corresponding phosphates, carbonates, oxides, sulphates, in particular of Mg, Zn and Ca, or the corresponding acetates, carboxylates (such as oxalates and acetates) come into consideration as source for the bivalent metal cation.

The invention is explained in more detail below with reference to examples and drawings which are not, however, to be considered limiting.

### BRIEF DESCRIPTION OF THE DRAWINGS

FIG. 1 an XRD diagram of LiMn_{0.80}Fe_{0.10}Zn_{0.10}PO₄ according to the invention;

FIG. 2 discharge curves at C/10 and at 1 C for a lithium-manganese iron phosphate LiMn_{0.80}Fe_{0.20}PO₄ according to the state of the art;

FIG. 3 discharge curves at C/10 and at 1 C for LiMn_{0.80}Fe_{0.10}Mg_{0.10}PO₄ according to the invention;

FIG. 4 discharge curves at C/10 and at 1 C for the LiMn_{0.56}Fe_{0.33}Zn_{0.1}PO₄ according to the invention;

FIG. 5 voltage profiles at 1 C after aging of LiMn_{0.56}Fe_{0.33}Mg_{0.10}PO₄ material according to the invention vis-à-vis lithium-manganese iron phosphate (LiMn_{0.66}Fe_{0.33}PO₄) of the state of the art;

### DETAILED DESCRIPTION

### Embodiment Examples

### 1. Determination of the Particle-Size Distribution:

The particle-size distributions for the mixtures or suspensions and of the produced material is determined using the light-scattering method using devices customary in the trade. This method is known per se to a person skilled in the art, wherein reference is also made in particular to the disclosure in JP 2002-151082 and WO 02/083555. In this case, the particle-size distributions were determined with the help of a laser diffraction measurement apparatus (Mastersizer S, Malvern Instruments GmbH, Herrenberg, DE) and the manufacturer's software (version 2.19) with a Malvern Small Volume Sample Dispersion Unit, DIF 2002 as measuring unit. The following measuring conditions were chosen: compressed range; active beam length 2.4 mm; measuring range: 300 RF; 0.05 to 900 μm. The sample preparation and measurement took place according to the manufacturer's instructions.

The D₉₀ value gives the value at which 90% of the particles in the measured sample have a smaller or the same particle diameter. Accordingly, the D₅₀ value and the D₁₀ value give the value at which 50% and 10% respectively of the particles in the measured sample have a smaller or the same particle diameter.

According to a particularly preferred embodiment according to the invention, the values named in the present description are valid for the D₁₀ values, D₅₀ values, the D₉₀ values as well as the difference between the D₉₀ and D₁₀ values relative to the volume proportion of the respective particles in the total volume. Accordingly, according to this embodiment according to the invention, the D₁₀, D₅₀ and D₉₀ values named here give the values at which 10 volume-% and 50 volume-% and 90 volume-% respectively of the particles in the measured sample have a smaller or the same particle diameter. If these values are preserved, particularly advantageous materials are provided according to the invention and negative influences of relatively coarse particles (with relatively larger volume proportion) on the processability and the electrochemical product properties are avoided. Particularly preferably, the values named in the present description are valid for the D₁₀ values, the D₅₀ values, the D₉₀ values as well as the difference between the D₉₀ and the D₁₀ values relative to both percentage and volume percent of the particles.

For compositions (e.g. electrode materials) which, in addition to the lithium-manganese iron phosphates according to the invention substituted with bivalent metal cations, contain further components, in particular for carbon-containing compositions, the above light scattering method can lead to misleading results as the LiFeₓMn_{1-x-y}M_{y}PO₄ particles can be joined together by the additional (e.g. carbon-containing) material to form larger agglomerates. However, the particle-size distribution of the material according to the invention can be determined as follows for such compositions using SEM photographs:

A small quantity of the powder sample is suspended in acetone and dispersed with ultrasound for 10 minutes. Immediately thereafter, a few drops of the suspension are dropped onto a sample plate of a scanning electron microscope (SEM). The solids concentration of the suspension and the number of drops are measured such that a largely single-ply layer of powder particles (the German terms “Partikel” and “Teilchen” are used synonymously to mean “particle”) forms on the support in order to prevent the powder particles from obscuring one another. The drops must be added rapidly before the particles can separate by size as a result of sedimentation. After drying in air, the sample is placed in the measuring chamber of the SEM. In the present example, this is a LEO 1530 apparatus which is operated with a field emission electrode at 1.5 kV excitation voltage and a 4 mm space between samples. At least 20 random sectional magnifications of the sample with a magnification factor of 20,000 are photographed. These are each printed on a DIN A4 sheet together with the inserted magnification scale. On each of the at least 20 sheets, if possible at least 10 free visible particles of the material according to the invention, from which the powder particles are formed together with the carbon-containing material, are randomly selected, wherein the boundaries of the particles of the material according to the invention are defined by the absence of fixed, direct connecting bridges. On the other hand, bridges formed by carbon material are included in the particle boundary. Of each of these selected particles, those with the longest and shortest axis in the projection are measured in each case with a ruler and converted to the actual particle dimensions using the scale ratio. For each measured LiFeₓMn_{1-x-y}MyPO₄ particle, the arithmetic mean from the longest and the shortest axis is defined as particle diameter. The measured LiFeₓMn_{1-x-y}MyPO₄ particles are then divided analogously to the light-scattering measurement into size classes. The differential particle-size distribution relative to the number of particles is obtained by plotting the number of the associated particles in each case against the size class. The cumulative particle-size distribution from which D₁₀, D₅₀ and D₉₀ can be read directly on the size axis is obtained by continually totalling the particle numbers from the small to the large particle classes.

The described process is also applied to battery electrodes containing the material according to the invention. In this case, however, instead of a powder sample a fresh cut or fracture surface of the electrode is secured to the sample holder and examined under a SEM.

### Example 1

### Production of LiMn_{0.56}Fe_{0.33}Mg_{0.1}PO₄ According to the Process According to the Invention

92.9 g Li₂CO₃ was wet-ground in isopropanol (Retsch PM400, 500 mL beaker, 100*10 mm balls, 380 rpm) with 47.02 g FePO₄. H₂O, 54.02 g MnCO₃ and 4.92 g Mg(OH)₂ and 5 wt.-% cellulose acetate (relative to the overall mass of the other reagents). The solvent was evaporated and the dry mixture was then sintered in a protective gas furnace (Linn KS 80-S) at 750° C. for 11 h. The thus-obtained product was then ground with a high-speed rotor mill (Pulverisette 14, Fritsche, 80 □m screen).

### Example 2

### Production of LiMn_{0.56}Fe_{0.33}Zn_{0.10}PO₄

The synthesis was carried out as in Example 1, except that 8.38 g Zn(OH)₂ was used as starting material in the corresponding molar weight quantities instead of Mg(OH)₂.

### Example 3

### Production of LiMn_{0.80}Fe_{0.10}Mg_{0.10}PO₄ According to the Process According to the Invention

The synthesis was carried out as in Example 1, except that 77.17 g MnCO₃, 14.25 g FePO₄.H₂O, 4.92 g Mg(OH)₂ were used as starting materials in the corresponding molar weight quantities.

### Example 4

### Production of LiMn_{0.56}Fe_{0.33}Mg_{0.10}PO₄ According to the Process According to the Invention (Carbothermal Variant)

The synthesis was carried out as in Example 1, except that the corresponding molar quantities of Fe₂O₃ and graphite were used instead of FePO₄x7H₂O.

### Example 5

### Production of LiMn_{0.80}Fe_{0.10}Mg_{0.1}PO₄ According to the Process According to the Invention (Carbothermal Variant)

The synthesis was carried out as in Examples 1 and 5, except that the corresponding molar quantity of Fe₂O₃ as well as double the stoichiometric quantity of graphite was used instead of FePO₄H₂O. The obtained carbon-containing LiMn_{0.80}Fe_{0.10}Mg_{0.10}PO₄ composite material contained the carbon evenly distributed throughout the material.

### Example 6

### Carbon Coating of the Obtained Material (Variant 1)

The materials obtained in Examples 1 to 3 were impregnated with a solution of 24 g lactose in water and then calcined at 750° C. for 3 hours under nitrogen.

Depending on the quantity of lactose, the proportion of carbon in the product according to the invention was between 0.2 and 4 wt.-%.

Typically 1 kg dry product from Examples 1 and 2 was mixed intimately with 112 g lactose monohydrate and 330 g deionized water and dried overnight in a vacuum drying oven at 105° C. and <100 mbar to a residual moisture of 3%. The brittle drying product was broken by hand and coarse-ground in a disk mill (Fritsch Pulverisette 13) with a 1 mm space between disks and transferred in high-grade steel cups into a protective gas chamber furnace (Linn KS 80-S). The latter was heated to 750° C. within 3 hours at a nitrogen stream of 200 l/h, kept at this temperature for 3 hours and cooled over 3 hours to room temperature. The carbon-containing product was disagglomerated in a jet mill (Hosokawa).

The SEM analysis of the particle-size distribution produced the following values: D₅₀<2 μm, difference between D₉₀ and D₁₀ value: <5 μm.

### Example 7

### Carbon Coating of the Material According to the Invention (Variant 2)

The synthesis of the materials according to the invention was carried out as in Examples 1 to 4, except that 20 g lactose was added to the mixture of starting materials. The end-product contained approx. 2.3 wt.-% carbon.

### Example 8

### Production of Electrodes

Thin-film electrodes as disclosed for example in Anderson et al., Electrochem. and Solid State Letters 3 (2) 2000, pages 66-68 were produced. The electrode compositions usually consisted of 90 parts by weight active material, 5 parts by weight Super P carbon and 5% polyvinylidene fluoride as binder or 80 parts by weight active material, 15 wt.-% Super P carbon and 5 parts by weight polyvinylidene fluoride, or 95 parts by weight active material and 5 parts by weight polyvinylidene fluoride.

The electrode suspensions were then applied with a coating knife to a height of approx. 150 μm. The dried electrodes were rolled several times or pressed with suitable pressure until a thickness of 20 to 25 μm was obtained. Corresponding measurements of the specific capacity and the current carrying capacity were carried out on both LiMn_{0.80}Fe_{0.20}PO₄ and LiMn_{0.66}Fe_{0.33}PO₄ of the state of the art and materials according to the invention substituted with magnesium and zinc.

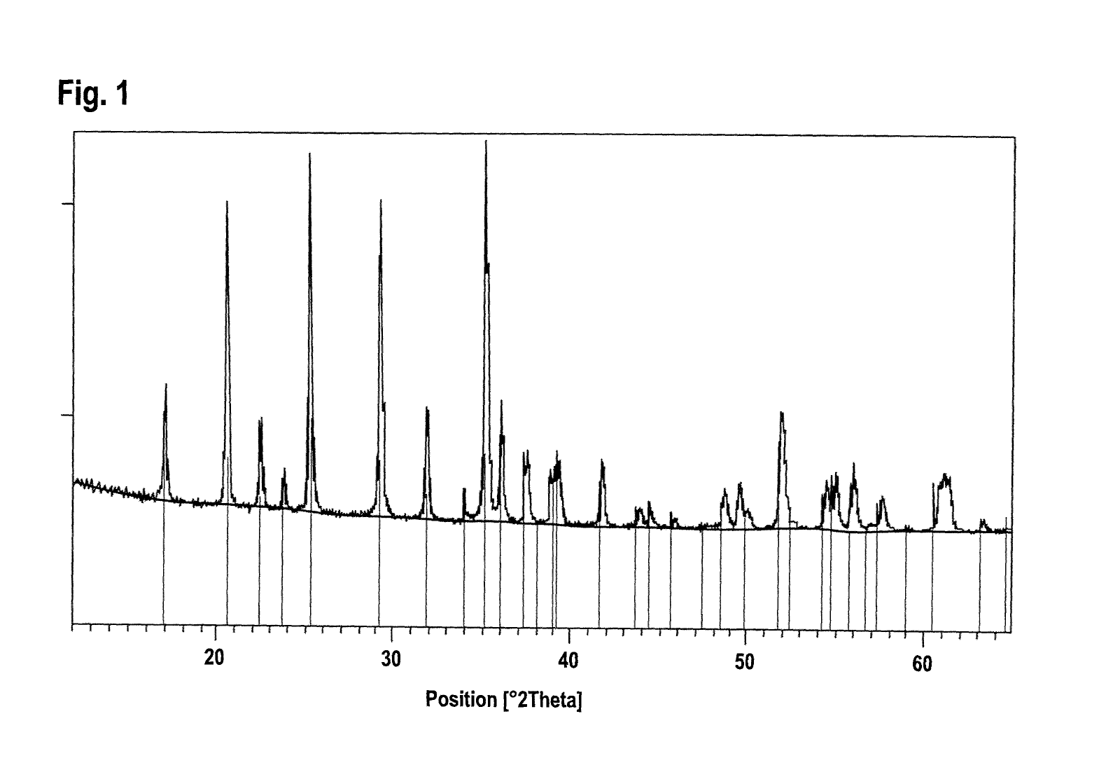

FIG. 1 shows an X-ray powder diffraction diagram of LiMn_{0.80}Fe_{0.10}Mg_{0.10}PO₄ according to the process according to the invention. The phase purity of the material was thus confirmed.

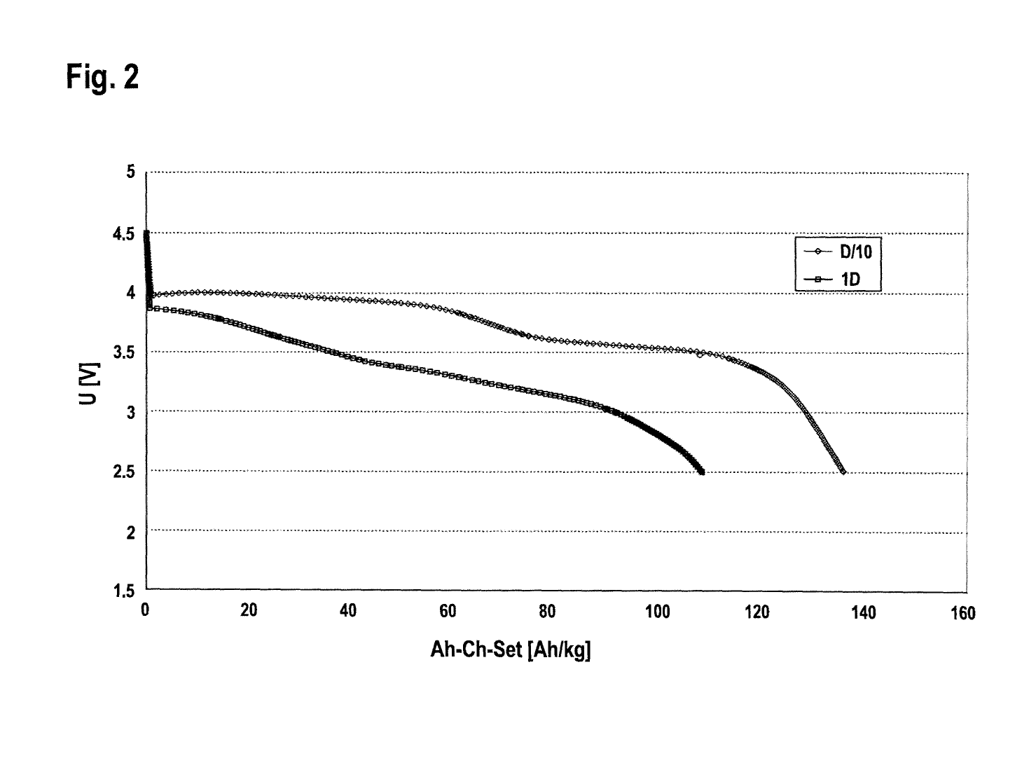

FIG. 2 shows the discharge curves at C/10 and at 1 C for a LiMn_{0.80}Fe_{0.20}PO₄ of the state of the art. The length of the plateau was approx. 60 mAh/g at C/10 and a very high polarization was always ascertained at the 1 C discharge rate both at the iron and manganese plateaus.

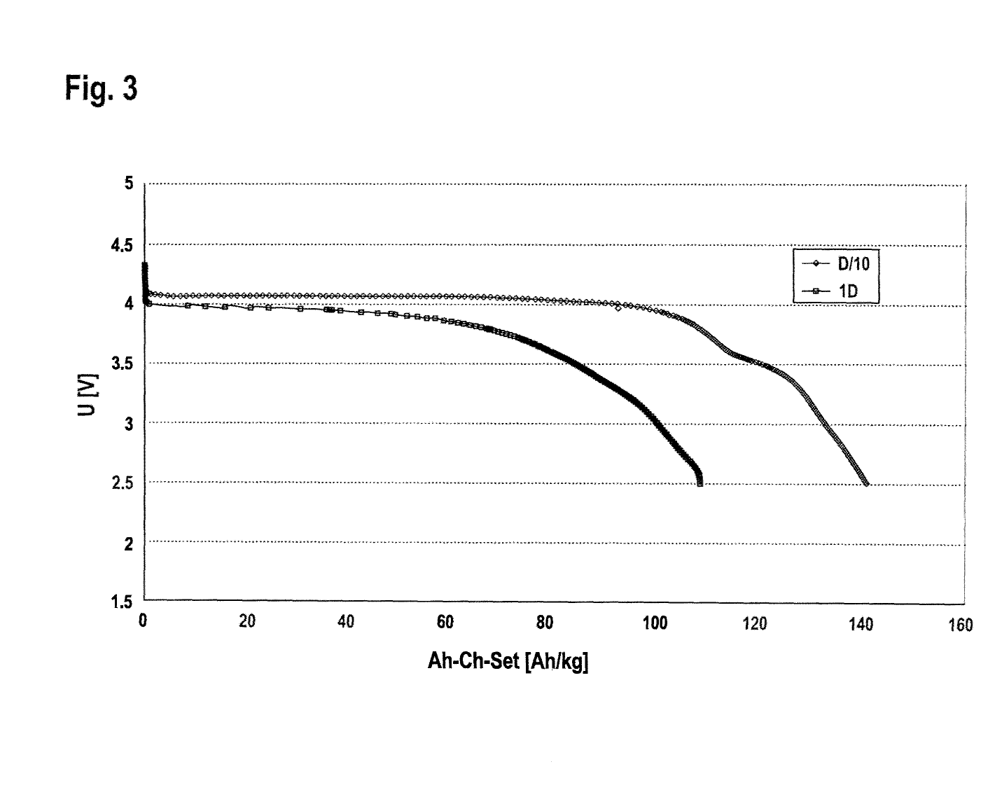

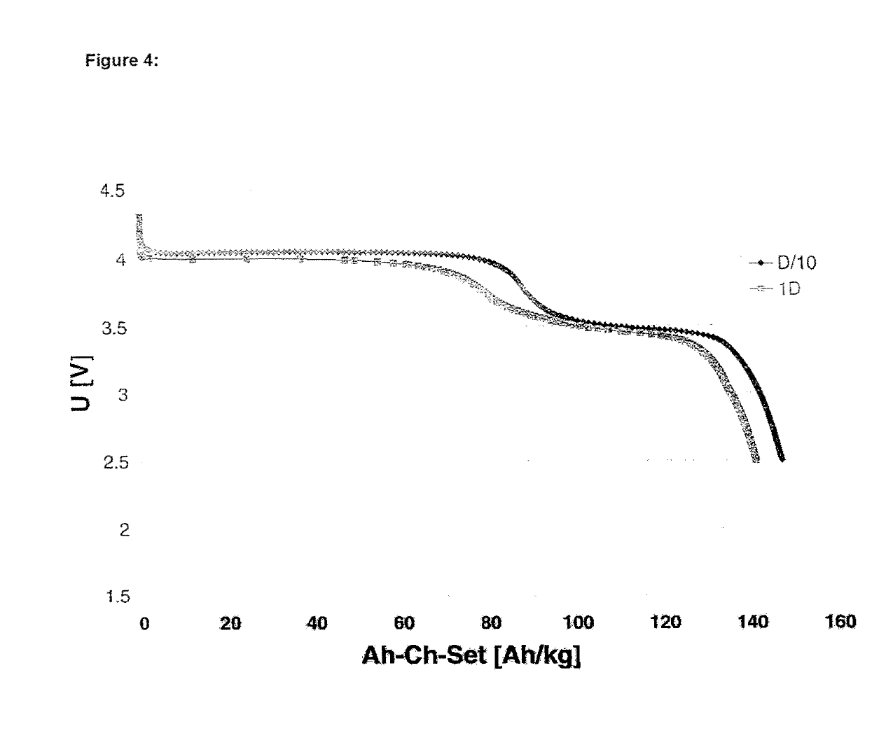

In contrast, the magnesium-substituted LiMn_{0.80}Fe_{0.10}Mg_{0.10}PO₄ material according to the invention (FIG. 3) surprisingly displays a much longer manganese plateau (>100 mAh/g) although the manganese content of the material was the same as in the material of the state of the art. In addition, the polarization at the 1 C discharge rate was low in the range of between 0 and 60 mAh/g. Likewise the magnesium-substituted LiMn_{0.56}Fe_{0.33}Mg_{0.10}PO₄ material according to the invention (FIG. 4) displays a very low polarization of the battery both at the manganese plateau and at the iron plateau.

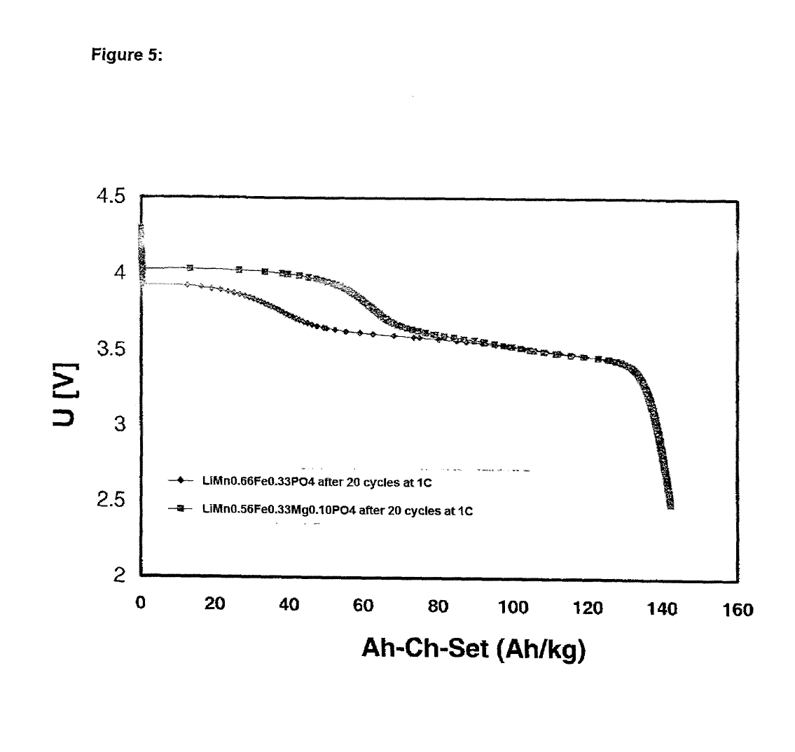

FIG. 5 shows a discharge curve at 1 C after aging (20 cycles at 1 C) for a LiMn_{0.66}Fe_{0.33}PO₄ material of the state of the art with an electrode density of 1.2 g/cm³ and a thickness of 20 μm. By way of comparison, the discharge curve at 1 C after similar aging (20 cycles at 1 C) for the magnesium-substituted LiMn_{0.56}Fe_{0.33}Mg_{0.10}PO₄ material according to the invention is shown in FIG. 5. It is surprisingly to be noted that the length of the manganese plateau in the LiMn_{0.56}Fe_{0.33}Mg_{0.10}PO₄ material is greater than in the LiMn_{0.66}Fe_{0.33}PO₄, material of the state of the art, although the manganese content of the material according to the invention was lower. As the specific capacity for both materials was similar, the LiMn_{0.56}Fe_{0.33}Mg_{0.10}PO₄ material displays a better energy density after aging in the battery than the material of the state of the art.

In summary, the present invention makes available mixed lithium-manganese iron phosphate materials substituted with bivalent metal ions, which can be produced by means of a solid-state process. The specific discharge capacity for room temperature exceeds 140 mAh/g despite the substitution with sometimes 10% electrochemically inactive bivalent metal ions. Very good discharge rates were measured for all the substituted materials.

Compared with non-substituted LiMn_{0.80}Fe_{0.20}PO₄ it was shown that even after several charge and discharge cycles the discharge voltage profile at 1 D for the bivalently substituted novel materials according to the invention [had] a very small drop in capacity in particular in the case of the manganese plateau (4V region) unlike the lithium-manganese iron phosphates not substituted with (electrically inactive) bivalent materials. The length of the manganese plateau also remains unchanged.

It was found with respect to the energy density that the substitution with magnesium or zinc gave the best results compared with calcium, copper, titanium and nickel. Further good results were obtained with magnesium and calcium.

1. A substituted lithium-manganese metal phosphate of formula
LiFeₓMn_{1-x-y}M_{y}PO₄
in which M is a bivalent metal selected from the group consisting of Sn, Pb, Zn, Mg, Ca, Sr, Ba, Co, Ti and Cd and wherein: x<1, y<0.3 and x+y<1.

2. Lithium-manganese metal phosphate according to claim 1, in which M is Zn or Ca.

3. Lithium-manganese metal phosphate according to claim 1, in which 0<y<0.15.

4. Lithium-manganese metal phosphate according to claim 1, in which 0<x<0.35.

5. Lithium-manganese metal phosphate according to claim 1, in which M is Mg.

6. Lithium-manganese metal phosphate according to claim 5, wherein 0.01≦x≦0.11, 0.07<y≦0.20 and x+y<0.2.

7. Lithium-manganese metal phosphate according to claim 1, further comprising carbon.

8. Lithium-manganese metal phosphate according to claim 7, wherein the carbon is evenly distributed throughout the substituted lithium-manganese metal phosphate.

9. Lithium-manganese metal phosphate according to claim 7, wherein the carbon covers the individual particles of the substituted lithium-manganese metal phosphate.

10. Lithium-manganese metal phosphate according to claim 7, wherein the proportion of carbon relative to the substituted lithium-manganese metal phosphate is ≦4 wt.-%.

11. Cathode for a secondary lithium-ion battery containing a lithium-manganese metal phosphate according to claim 1.

12. Cathode according to claim 11, containing a further lithium-metal-oxygen compound.

13. Cathode according to claim 12, wherein the further lithium-metal-oxygen compound is selected from the group LiCoO₂, and LiNiO₂, LiFePO₄, LiMnPO₄ and LiMnFePO₄ as well as mixtures thereof.

14. Cathode according to claim 11, which is free of added conductive agents.

15. Process for producing a lithium-manganese metal phosphate according to claim 1, comprising the following steps:
a. producing a mixture containing at least a Li starting compound, a Mn starting compound, an Fe starting compound, a M²⁺ starting compound and a PO₄³⁻ starting compound,
b. heating the mixture at a temperature of 450-850° C.,
c. isolating the lithium-manganese metal phosphate LiFeₓMn_{1-x-y}M_{y}PO₄.

16. Process according to claim 15, wherein in step a) a further, carbon-containing, component is added.

17. Process according to claim 15, wherein the LiFeₓMn_{1-x-y}M_{y}PO₄ obtained in step c) is mixed with a carbon-containing component.

18. Process according to claim 15, wherein LiOH, Li₂O, lithium oxalate, lithium acetate or Li₂CO₃ is used as lithium source.

19. Process according to claim 16, wherein an Fe²⁺ salt, selected from FeSO₄, FeCl₂, Fe₃(PO₄)₂, FeO, FeHPO₄ or an iron-organyl salt or an Fe³⁺ salt, selected from FePO₄, Fe₂O₃, FeCl₃ or a mixed Fe salt such as Fe₃O₄ is used as Fe source.

20. Process according to claim 17, wherein a Mn²⁺ salt, selected from MnSO₄, MnCl₂, MnO, MnHPO₄, manganese oxalate, manganese acetate or a Mn³⁺ salt, selected from MnPO₄, Mn₂O₃, MnCl₃ or a mixed manganese salt such as Mn₃O₄ is used as Mn source.

21. Process according to claim 18, wherein phosphoric acid, a phosphate, hydrogen phosphate, dihydrogen phosphate or P₂O₅ is used as PO₄³⁻ source.
